(19) United States
(12) Patent Application Publication
(10) Pub. No.: US 2009/0237558 A1
(43) Pub. Date: Sep. 24, 2009

(54) TELETEXT RECEIVING CIRCUIT

(76) Inventors: Kazuya Miyashita, Osaka (JP); Keiichi Kuzumoto, Osaka (JP)

Correspondence Address: MCDERMOTT WILL & EMERY LLP, 600 13TH STREET, NW, WASHINGTON, DC, 20005-3096, US

(21) Appl. No.: 12/307,683

(22) PCT Filed: May 14, 2008
(86) PCT No.: PCT/JP2008/001203

§ 371 Date: Jan. 6, 2009

(30) Foreign Application Priority Data
May 28, 2007 (JP) 2007 140887

(51) Int. Cl. H04N 7/00

(52) U.S. Cl. 348/468; 348/E07.001

(57) ABSTRACT

A band-pass filter (131), which extracts a frequency component of a teletext reference signal from a digital input signal obtained by digitizing a composite signal, is provided in a frequency characteristic enhancement circuit (130). A determination circuit (145), which determines a state of the composite signal in accordance with maximum and minimum values of an output of the frequency characteristic enhancement circuit (130) during the period of the teletext reference signal and in accordance with maximum and minimum values of the output of the frequency characteristic enhancement circuit (130) during the period of time between a current horizontal synchronization interval and a next horizontal synchronization interval, is provided in a slicing circuit (140). A signal to be output to the slicing circuit (140) is generated by the frequency characteristic enhancement circuit (130) in accordance with either an output of the band-pass filter (131) or the digital input signal which is selected according to a determination result obtained by the determination circuit (145).

### TECHNICAL FIELD

The present invention relates to a teletext receiving circuit for receiving a teletext signal superimposed on a vertical blanking interval in an analog TV composite signal.

### BACKGROUND ART

A teletext signal is sometimes superimposed on a vertical blanking interval in an analog TV composite signal. Examples of a teletext receiving circuit for receiving such a teletext signal include a circuit illustrated in a block diagram in FIG. 3. This teletext receiving circuit includes an A/D converter 310, a horizontal synchronizing signal detection/CRI window generation section 320, a frequency characteristic enhancement circuit 330, a CPU 340, a slicing circuit 350, a teletext data decoding circuit 360, a teletext data storage section 370, and an OSD (On Screen Display) 380, and receives an analog TV composite signal S400. A teletext signal is superimposed on the vertical blanking interval in the analog TV composite signal S400.

The A/D converter 310 digitizes the analog TV composite signal S400 and outputs the digitized signal to the frequency characteristic enhancement circuit 330.

The horizontal synchronizing signal detection/CRI window generation section 320 detects a horizontal synchronization interval in the analog TV composite signal S400, and, based on the detection result, generates a CRI window indicating a clock run-in (CRI) period showing a reference waveform for the teletext signal.

The frequency characteristic enhancement circuit 330 is a circuit for compensating for the frequency band of a CRI signal which is a reference signal for the teletext signal, and includes a band-pass filter 331 (which is abbreviated as BPF in the figure), a multiplier 332, and an adder 333.

The band-pass filter 331 only extracts a frequency of the input teletext signal that contains the clock run-in signal. The multiplier 332 multiplies the output of the band-pass filter 331 by a multiplier (which will be described later) provided by the CPU 340, and outputs the multiplication result to the adder 333. The adder 333 adds the output of the A/D converter 310 and the output of the multiplier 332 together and outputs the result to the slicing circuit 350.

The CPU 340 monitors the amplitude of the output (i.e., the frequency component of the CRI signal) of the band-pass filter 331 and provides the multiplier 332 with the appropriate multiplier in accordance with the monitoring results. In this way, the target amplitude of the CRI signal is maintained without relying on an externally input amplitude. That is, the characteristics of the frequency component of the CRI signal are enhanced.

The slicing circuit 350 includes a MIN/MAX circuit 351, a teletext data extraction circuit 353, and a slicing level calculation circuit 352. The MIN/MAX circuit 351 monitors the amplitude value during the CRI period indicated by the horizontal synchronizing signal detection/CRI window generation section 320, and outputs the minimum and maximum of the amplitude value to the slicing level calculation circuit 352. From the minimum and maximum values obtained by the MIN/MAX circuit 351, the slicing level calculation circuit 352 determines a threshold value for binarizing the teletext signal and identifying 0/1, and outputs the threshold value to the teletext data extraction circuit 353. From the threshold value provided by the slicing level calculation circuit 352, the teletext data extraction circuit 353 substitutes data of 0/1 for the teletext signal data output from the frequency characteristic enhancement circuit 330, and outputs the data of 0/1 to the teletext data decoding circuit 360 in the subsequent stage.

The teletext data decoding circuit 360 decodes the output of the teletext data extraction circuit 353 in accordance with a format in the broadcast system. The teletext data storage section 370 stores therein the output of the teletext data decoding circuit 360.

Under control of the CPU 340, the OSD 380 displays the teletext data in the teletext data storage section 370 on an output destination (for example, on the screen of a TV).

The operation of the teletext receiving circuit described above, in particular, the operation of the frequency characteristic enhancement circuit 330, will be described in the order of signal flow.

FIG. 4 shows an example of the waveform of the analog TV composite signal S400 in the vertical blanking interval. Teletext signals are transmitted in accordance with systems which differ from area to area around the world, and these teletext signals can thus be identified by the broadcast systems, the transmission rates, the superimposition lines, etc. For example, for World System Teletext (which will be hereinafter referred to as “WST”) transmitted in Europe, the transmission rate is 6.9375 MHz/bit, and the superimposition lines are from 7 to 22.

The analog TV composite signal S400 is an example of a signal in the lines on which WST is superimposed. The analog TV composite signal S400 contains a horizontal synchronizing signal S401, which determines a vertical location, and a burst signal S402, which is related to color signal demodulation technique. Also, a clock run-in signal S403, a framing code S404, and a teletext data signal S405 are the elements forming the teletext signal.

The clock run-in signal S403 is a reference for the teletext signal, and is related to a reference level for determining a value of 0/1 for the teletext data. In WST, the clock run-in signal S403 is “1010101010101010” when 0/1 digitized, and has a frequency component of approximately 3.5 MHz. The framing code S404 indicates the type of the teletext signal, and is “11100100” in WST. The teletext data signal S405 is teletext data, and, in WST, always 42-byte data.

As indicated by S501 in FIG. 5, the analog TV composite signal S400 has a band up to 6.3975 MHz, and when the analog TV composite signal S400 passes through the frequency characteristic enhancement circuit 330, a part in the vicinity of 3.5 MHz, which is the clock run-in signal S403, is amplified by the multiplier provided from the CPU 340. Therefore, as indicated by S502 in FIG. 5, for example, when the amplitude characteristics of the clock run-in signal S403 are not sufficient due to effects of the transmission path or the like, the frequency characteristics can be compensated for by the frequency characteristic enhancement circuit 330 as indicated by S503.

The MIN/MAX circuit 351 detects the minimum value 4A (see FIG. 4) and the maximum value 4B (see FIG. 4) of the amplitude during the CRI period indicated by the CRI window generated by the horizontal synchronizing signal detection/CRI window generation section 320, and provides the detected values to the CPU 340. From the minimum and maximum values 4A and 4B of the amplitude, the slicing level calculation circuit 352 determines the midpoint level 4C (see FIG. 4) as the slicing level for the 0/1 digitization. And the framing code S404 and the teletext data signal S405 are decoded using the midpoint level 4C as the reference level.

As described above, the frequency characteristic enhancement circuit 330 amplifies the amplitude of the CRI signal band to increase the operation accuracy of the slicing circuit 350, thereby contributing to the teletext signal receiving capability.

Other examples of a teletext receiving circuit include a circuit in which input data is binarized and decoded at a plurality of slicing levels to generate a plurality of pieces of decoded data, and then decoded data containing no errors is selected from those pieces of decoded data (see Patent Document 1, for example).

### Patent Document 1: Japanese Laid-Open Publication No. 2004-40350

### DISCLOSURE OF THE INVENTION

### Problem that the Invention Intends to Solve

However, in the above-described frequency characteristic enhancement circuit, when the input (i.e., the analog TV composite signal) is minute, it is not possible to make the amplitude of the teletext data satisfy the set slicing level just by amplifying the frequency band of the clock run-in signal, and thus the possibility that the teletext data would be erroneously extracted increases. This means that, in that case, the teletext data also needs amplitude amplification.

In view of the problem described above, the present invention has been made, and it is therefore an object of the present invention to provide a necessary signal amplitude to a signal which is input to a slicing circuit, even when an analog TV composite signal having a minute amplitude is input.

### Means for Solving the Problem

In order to achieve the object, an inventive teletext receiving circuit for receiving a teletext signal superimposed on a vertical blanking interval in an analog TV composite signal includes: a frequency characteristic enhancement circuit for amplifying a frequency band of the teletext signal when the frequency band has an amplitude lower than a predetermined level; and a slicing circuit for binarizing an output of the frequency characteristic enhancement circuit and outputting binarized data.

### EFFECTS OF THE INVENTION

According to the present invention, even when an analog TV composite signal having a minute amplitude is input, a necessary signal amplitude is provided to a signal which is input to a slicing circuit.

### BRIEF DESCRIPTION OF DRAWINGS

FIG. 1 is a block diagram illustrating the configuration of a teletext receiving circuit 100 according to a first embodiment.

FIG. 2 is a block diagram illustrating the configuration of a teletext receiving circuit 200 according to a second embodiment.

FIG. 3 is a block diagram illustrating an example of a conventional teletext receiving circuit.

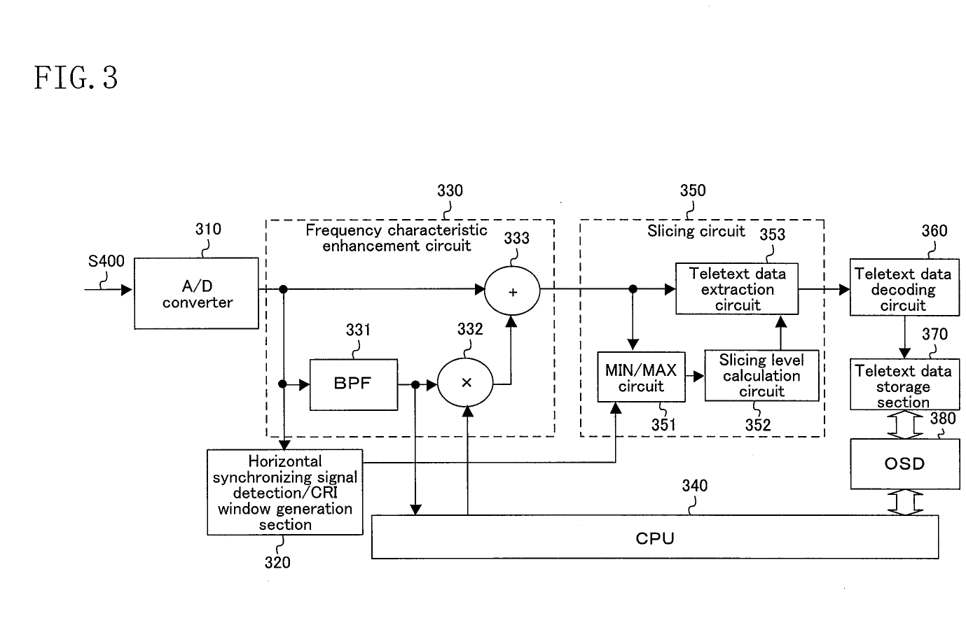

FIG. 4 shows an example of the waveform of an analog TV composite signal in a vertical blanking interval.

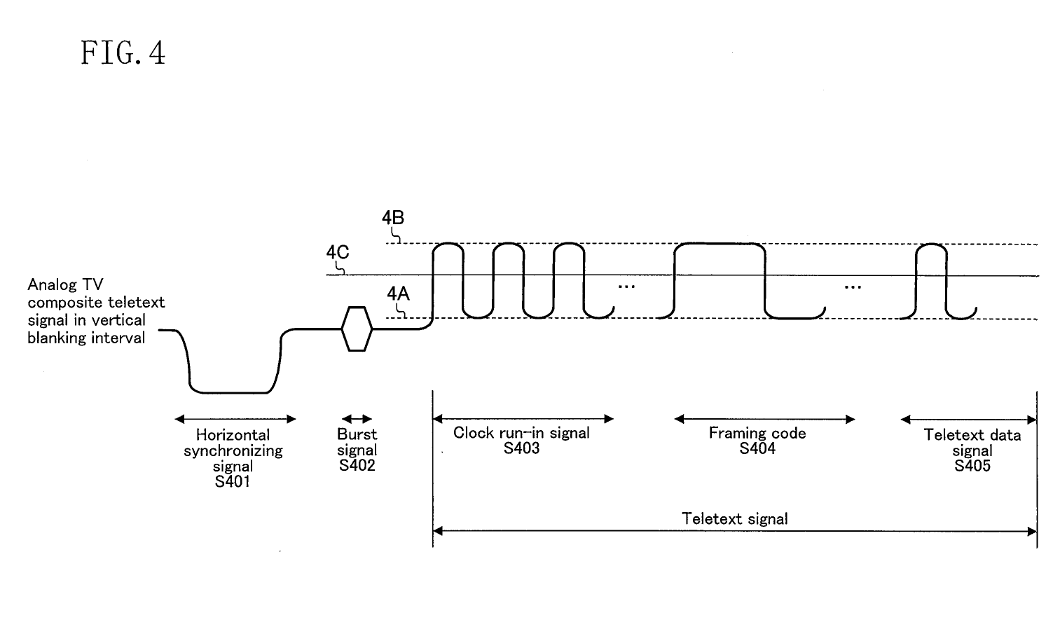

FIG. 5 is an explanatory view of a teletext signal band.

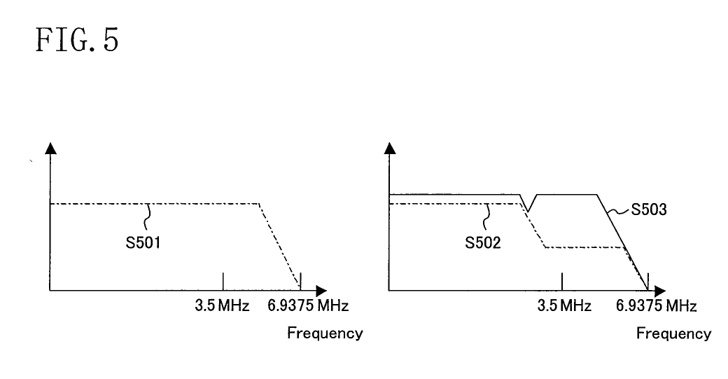

### EXPLANATION OF THE REFERENCE CHARACTERS

100 Teletext receiving circuit
110 A/D converter
120 Horizontal synchronizing signal detection/CRI window generation section
130 Frequency characteristic enhancement circuit
131 Band-pass filter
132 Selection circuit
133 Multiplier
134 Adder
140 Slicing circuit
141 First MIN/MAX circuit
142 Second MIN/MAX circuit
143 Slicing level calculation circuit
144 Teletext data extraction circuit
145 Determination circuit
150 Teletext data decoding circuit
160 Teletext data storage section
170 OSD
180 CPU
200 Teletext receiving circuit
210 Low-pass filter
220 Weak electric field detection circuit
S101 Analog TV composite signal
S102 Digital input signal

### BEST MODE FOR CARRYING OUT THE INVENTION

Hereinafter, the embodiments of the present invention will be described with reference to the accompanying drawings. In the descriptions of the following embodiments, components having the same functions as those already described are identified by the same reference numerals, and the descriptions thereof will be omitted.

### First Embodiment

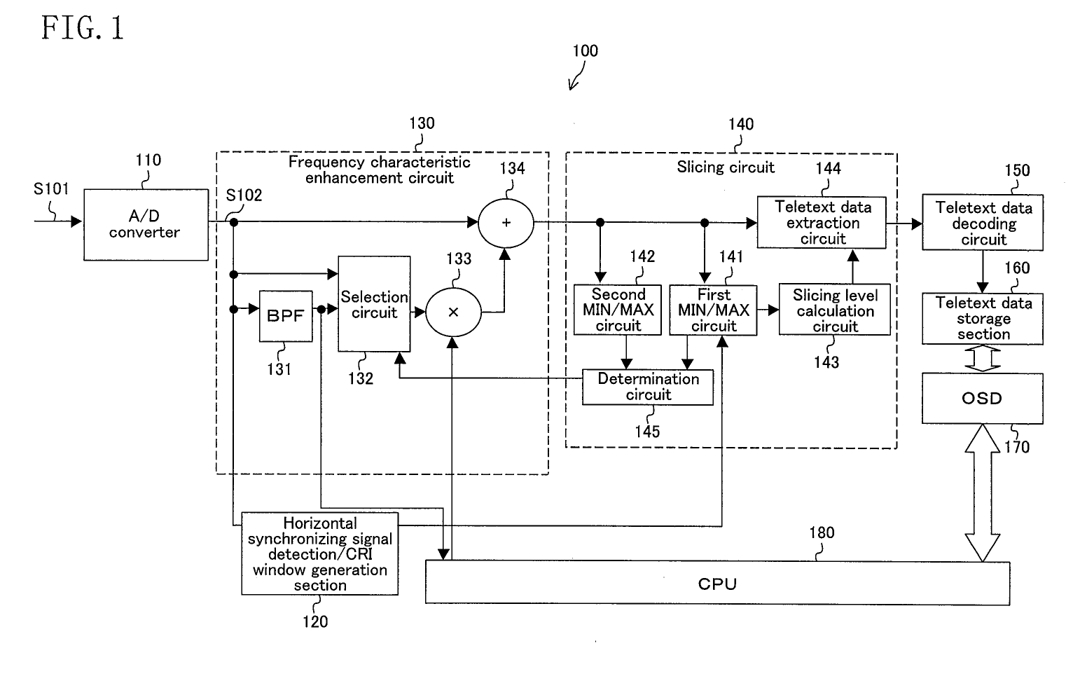

FIG. 1 is a block diagram illustrating the configuration of a teletext receiving circuit 100 according to a first embodiment of the present invention. As shown in FIG. 1, the teletext receiving circuit 100 includes an A/D converter 110, a horizontal synchronizing signal detection/CRI window generation section 120, a frequency characteristic enhancement circuit 130, a slicing circuit 140, a teletext data decoding circuit 150, a teletext data storage section 160, an OSD (On Screen Display) 170, and a CPU 180.

The A/D converter 110 receives an analog TV composite signal S101 and digitizes the input signal to output the digitized signal to the frequency characteristic enhancement circuit 130. The analog TV composite signal S101 is a signal in which a teletext signal is superimposed on the vertical blanking interval.

The horizontal synchronizing signal detection/CRI window generation section 120 detects a horizontal synchronization interval in the analog TV composite signal S101, and, based on the detection results, generates a CRI window indicating a clock run-in (which will be hereinafter referred to as “CRI”) period showing a reference waveform for the teletext signal.

The frequency characteristic enhancement circuit 130 compensates for the frequency band of a CRI signal which is a reference signal for the teletext signal. The frequency characteristic enhancement circuit 130 includes a band-pass filter 131 (abbreviated as BPF in the figure), a selection circuit 132, a multiplier 133, and an adder 134.

The band-pass filter 131 only extracts a frequency of the input teletext signal that contains the CRI signal (which is the reference signal for the teletext signal). For example, in a case in which the analog TV composite signal S101 is World System Teletext (which will be hereinafter referred to as “WST”) transmitted in Europe, the band-pass filter 131 is a digital band-pass filter that has a center frequency of approximately 3.5 MHz, which is the CRI signal frequency. In WST, the transmission rate is 6.9375 MHz/bit, and the superimposition lines are from 7 to 22.

The selection circuit 132 receives the output data (which will be called a digital input signal S102) of the A/D converter 110 and the output data of the band-pass filter 131, and selects and outputs one of these input data in accordance with a determination result obtained by a determination circuit 145 (which will be described later) in the slicing circuit 140.

The multiplier 133 multiplies the output of the selection circuit 132 by a multiplier (which will be described later) returned form the CPU 180.

The adder 134 adds the multiplication result obtained by the multiplier 133 and the digital input signal S102 together, and outputs the result to the slicing circuit 140 in the subsequent stage.

The slicing circuit 140 binarizes the output of the frequency characteristic enhancement circuit 130 and outputs the binarized data. The slicing circuit 140 includes a first MIN/MAX circuit 141, a second MIN/MAX circuit 142, a slicing level calculation circuit 143, a teletext data extraction circuit 144, and the determination circuit 145.

The first MIN/MAX circuit 141 monitors the amplitude value of the output of the frequency characteristic enhancement circuit 130 during the CRI period, and detects and outputs the minimum and maximum of the amplitude value to the slicing level calculation circuit 143 and to the determination circuit 145.

The second MIN/MAX circuit 142 detects the maximum and minimum of the output of the frequency characteristic enhancement circuit 130 during the period of time between the current horizontal synchronization interval and the next horizontal synchronization interval, and outputs the results to the determination circuit 145.

The slicing level calculation circuit 143 determines a threshold value for identification of 0/1 of the teletext signal in accordance with the output of the first MIN/MAX circuit 141, and outputs the threshold value to the teletext data extraction circuit 144.

Based on the threshold value determined by the slicing level calculation circuit 143, the teletext data extraction circuit 144 substitutes data of 0/1 for the teletext signal data output from the frequency characteristic enhancement circuit 130, and outputs the data of 0/1 to the teletext data decoding circuit 150 in the subsequent stage.

The determination circuit 145 controls the selection of the output data by the selection circuit 132 in accordance with the maximum and minimum values output from the first MIN/MAX circuit 141 and the difference between these maximum and minimum values and in accordance with the maximum and minimum values output from the second MIN/MAX circuit 142 and the difference between these maximum and minimum values.

Specifically, when these four values, i.e., the maximum and minimum values output from the first MIN/MAX circuit 141 and the maximum and minimum values output from the second MIN/MAX circuit 142, fall within a predetermined value range, the determination circuit 145 determines that the analog TV composite signal S101 is a minute signal, and makes the selection circuit 132 select and output the digital input signal S102.

When the difference between the maximum and minimum values output from the first MIN/MAX circuit 141 is greater than a predetermined value, and the difference between the maximum and minimum values output from the second MIN/MAX circuit 142 is also greater than a predetermined value, the determination circuit 145 determines that a normal operation (i.e., an operation performed when the analog TV composite signal S101 is a normal signal) is performed, and makes the selection circuit 132 select and output the output data of the band-pass filter 131.

When the difference between the maximum and minimum values output from the first MIN/MAX circuit 141 is greater than a predetermined value while the difference between the maximum and minimum values output from the second MIN/MAX circuit 142 is smaller than a predetermined value, the determination circuit 145 determines that the analog TV composite signal S101 is in an abnormal condition, and makes the selection circuit 132 select and output the digital input signal S102 so as to amplify the band of the entire input signal.

The teletext data decoding circuit 150 decodes the output of the teletext data extraction circuit 144 in accordance with a format in the broadcast system.

The teletext data storage section 160 stores therein the output of the teletext data decoding circuit 150.

Under control of the CPU 180, the OSD 170 displays the teletext data in the teletext data storage section 160 on an output destination (for example, on the screen of a TV).

The CPU 180 monitors the amplitude of the CRI signal frequency band in the output of the band-pass filter 131, and provides the multiplier 133 with an appropriate multiplier in accordance with the monitoring results so as to achieve the target signal amplitude.

(Operation of the Teletext Receiving Circuit 100)

When a signal having a minute amplitude is input to the teletext receiving circuit 100, the amplitude of the CRI signal is also small. This causes the maximum and minimum values output from the first MIN/MAX circuit 141 to be smaller than usual, and thus the difference between these maximum and minimum values also becomes smaller. Furthermore, since the amplitude of the signal other than the CRI signal portion is also considered small, the maximum and minimum values output from the second MIN/MAX circuit 142 are also smaller than usual, and the difference between these maximum and minimum values thus becomes smaller. Therefore, the determination circuit 145 makes the selection circuit 132 select and output the digital input signal S102. On the other hand, the CPU 180 monitors the amplitude of the CRI signal frequency band in the output of the band-pass filter 131, and provides the multiplier 133 with an appropriate multiplier in accordance with the monitoring results so as to achieve the target signal amplitude.

Consequently, the digital input signal S102 itself is input to the multiplier 133, so that not only the CRI signal band, but also the band of the entire input signal is amplified. And the adder 134 adds the multiplication result obtained by the multiplier 133 and the digital input signal S102 together, and outputs the result to the slicing circuit 140. As a result, a necessary sufficient signal amplitude is provided to the slicing circuit 140.

At this time, the difference between the maximum and minimum values output from the first MIN/MAX circuit 141 is greater than a predetermined value, and the difference between the maximum and minimum values output from the second MIN/MAX circuit 142 is also greater than a predetermined value. In this case, the determination circuit 145 determines that a normal operation is performed, and makes the selection circuit 132 select and output the output data of the band-pass filter 131.

However, even in the case in which the determination circuit 145 determines that a normal operation is performed, if the input to the teletext receiving circuit 100 continues to have a minute amplitude, only the frequency band of the CRI signal is amplified, which may cause the signal amplitude of the teletext data to fail to achieve the signal amplitude necessary for the slicing circuit 140. In that case, it is considered that the difference between the maximum and minimum values output from the first MIN/MAX circuit 141 is greater than a predetermined value, while the difference between the maximum and minimum values output from the second MIN/MAX circuit 142 is smaller than a predetermined value.

Therefore, the determination circuit 145 determines that the input signal is in an abnormal condition, and makes the selection circuit 132 select and output the output of the A/D converter 110 so as to amplify the band of the entire input signal. As a result, a necessary sufficient signal amplitude is provided again to the slicing circuit 140.

As described above, according to this embodiment, the detection results obtained by the first and second MIN/MAX circuits 141 and 142 are used in the determination circuit 145 to make determinations about the input signal and thereby identify each case. This allows the selection circuit 132 to select the signal band to be amplified. For example, when a minute signal is input, the entire band of the digital input signal S102 is amplified.

Hence, even when a minute signal is input, a necessary signal amplitude is provided to the signal that is input to the slicing circuit 140, thereby enabling the slicing level calculation and the teletext data extraction characteristics in the later stages to be enhanced.

It should be noted that the center frequency (3.5 MHz) of the band-pass filter 131 is just an example, and a reference signal frequency that each teletext signal has can be the center frequency of the filter.

### Second Embodiment

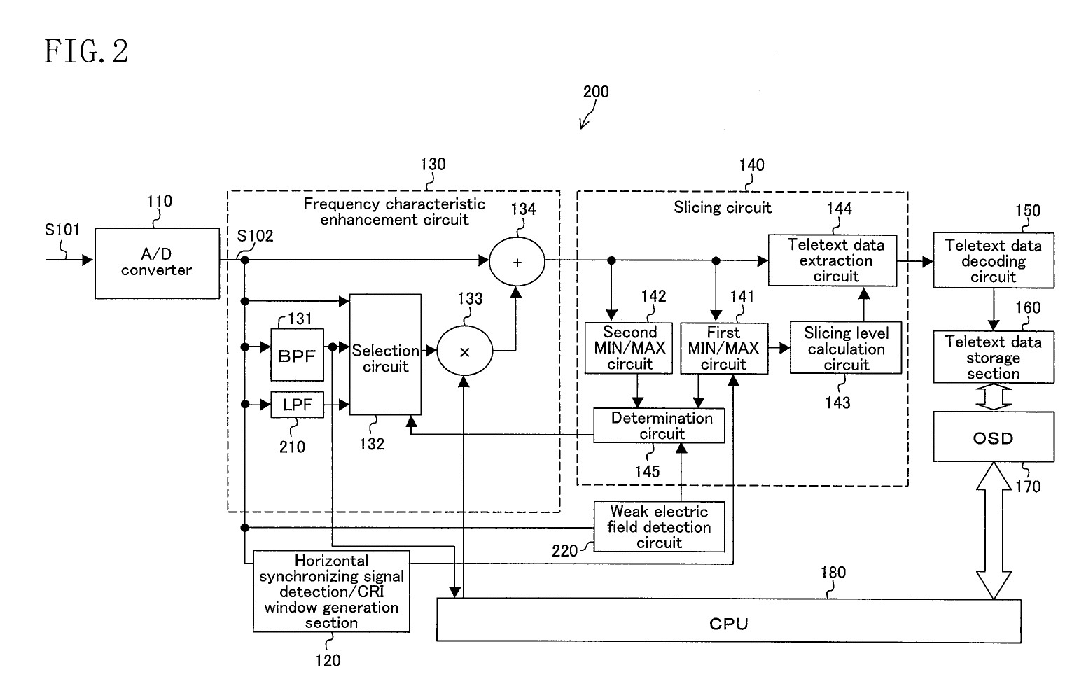

FIG. 2 is a block diagram illustrating the configuration of a teletext receiving circuit 200 according to a second embodiment of the present invention. As shown in FIG. 2, the teletext receiving circuit 200 is obtained by adding a low-pass filter 210 (which is abbreviated as LPF in the figure) and a weak electric field detection circuit 220 to the teletext receiving circuit 100. As a result of the addition of theses members, the functions of the selection circuit 132 and of the determination circuit 145 are changed as will be described later.

The low-pass filter 210 is added to a frequency characteristic enhancement circuit 130. The low-pass filter 210 is a digital low-lass filter for removing only part of an input teletext signal whose frequency is higher than a CRI signal frequency, and a digital input signal S102 is input to the low-pass filter 210.

In the teletext receiving circuit 200, a selection circuit 132 receives the digital input signal S102, the output data of a band-pass filter 131, and the output data of the low-pass filter 210, and selects and outputs one of these three output data in accordance with a determination result obtained by a determination circuit 145.

The weak electric field detection circuit 220 detects whether or not an analog TV composite signal S101 has a weak electric field, and outputs the detection result to the determination circuit 145. To be specific, the weak electric field detection circuit 220 detects whether or not the digital input signal S102 is a signal having a small amplitude and a high noise ratio (i.e., a noise condition signal).

In the teletext receiving circuit 200, when the weak electric field detection circuit 220 determines that the digital input signal S102 is not a noise condition signal, the determination circuit 145 makes the selection circuit 132 select either the digital input signal S102 or the output data of the band-pass filter 131 in accordance with the same determination criteria as in the first embodiment. On the other hand, when the weak electric field detection circuit 220 determines that the digital input signal S102 is a noise condition signal, the difference between maximum and minimum values detected by a first MIN/MAX circuit 141 is equal to or smaller than a predetermined value, and the difference between maximum and minimum values detected by a second MIN/MAX circuit 142 is equal to or smaller than a predetermined value, then the determination circuit 145 makes the selection circuit 132 select and output the output data of the low-pass filter 210.

(Operation of the Teletext Receiving Circuit 200)

The operation of the teletext receiving circuit 200 will be described by taking a case in which the analog TV composite signal S101 is WST by way of example.

In a case in which a teletext signal is WST, if a signal having a weak electric field, that is, a signal having a small amplitude and a high noise ratio, is input to the teletext receiving circuit 200, the analog TV composite signal S101 is considered to have a minute amplitude and contain a signal whose frequency is higher than the transmission rate, i.e., 6.9375 MHz. Consequently, the difference between the maximum and minimum values output from the first MIN/MAX circuit 141 is small, and the difference between the maximum and minimum values output from the second MIN/MAX circuit 142 is also small. At the same time, the weak electric field detection circuit 220 detects the weak electric field condition.

Hence, the determination circuit 145 determines that the input signal has a weak electric field, and makes the selection circuit 132 select the output data of the low-pass filter 210 so as to remove the noise component whose frequency is higher than the transmission rate from the digital input signal S102.

On the other hand, the CPU 180 monitors the amplitude of the CRI signal frequency band in the output of the band-pass filter 131, and provides a multiplier 133 with an appropriate multiplier in accordance with the monitoring results so as to achieve a signal amplitude necessary for a slicing circuit 140. Then, the multiplier 133 multiplies the output data of the low-pass filter 210 by the provided multiplier, and outputs the result to an adder 134. The adder 134 adds the multiplication result obtained by the multiplier 133 and the digital input signal S102 together, and outputs the result to the slicing circuit 140. As a result, the slicing circuit 140 is provided with the signal from which the high-frequency component noise, specific to the weak electric field condition, has been removed in advance and which has a necessary sufficient signal amplitude.

At this time, the difference between the maximum and minimum values output from the first MIN/MAX circuit 141 is greater than a predetermined value, and the difference between the maximum and minimum values output from the second MIN/MAX circuit 142 is also greater than a predetermined value. In this case, the determination circuit 145 determines that a normal operation is performed, and makes the selection circuit 132 select and output the output data of the band-pass filter 131.

However, even in the case in which the determination circuit 145 determines that a normal operation is performed, if the input to the teletext receiving circuit 100 continues to have the weak electric field, only the frequency band of the CRI signal is amplified by the multiplier 133, which may cause the signal amplitude of the teletext data to fail to achieve the signal amplitude necessary for the slicing circuit 140. In that case, it is considered that the difference between the maximum and minimum values output from the first MIN/MAX circuit 141 is greater than a predetermined value, while the difference between the maximum and minimum values output from the second MIN/MAX circuit 142 is smaller than a predetermined value.

Therefore, the determination circuit 145 determines that the input signal is in an abnormal condition, and makes the selection circuit 132 select and output the output of the A/D converter 110 so as to amplify the band of the entire input signal. As a result, a necessary sufficient signal amplitude is provided again to the slicing circuit 140.

As described above, according to this embodiment, the detection results obtained by the first and second MIN/MAX circuits 141 and 142 and obtained by the weak electric field detection circuit 220 are used in the determination circuit 145 to make determinations about the input signal and thereby identify each case. This allows the selection circuit 132 to select the signal band to be amplified. For example, when the analog TV composite signal S101 is a noise condition signal, the entire band of the digital input signal S102, from which noise component has been removed, is amplified.

Accordingly, even in the case of a weak-electric-field input, it is possible to stably provide a necessary signal amplitude to the slicing circuit 140, thereby enabling the slicing level calculation and the teletext data extraction characteristics in the later stages to be enhanced.

It should be noted that the cut-off frequency (which is the transmission rate, i.e., 6.9375 MHz, in the above-described example) of the low-pass filter 210 is just an example, and may be set by a signal band that each teletext signal has.

Moreover, the WST signals described as the teletext signal inputs in the first and second embodiments are also examples, and the teletext signal inputs may be any teletext signals around the world.

### INDUSTRIAL APPLICABILITY

In the teletext receiving circuits according to the present invention, even when an analog TV composite signal having a minute amplitude is input, a necessary signal amplitude is provided to a signal that is input to a slicing circuit. Thus, the inventive teletext receiving circuits are applicable to teletext receiving circuits for receiving a teletext signal superimposed on a vertical blanking interval in an analog TV composite signal, and the like.

1. A teletext receiving circuit for receiving a teletext signal superimposed on a vertical blanking interval in an analog TV composite signal, the teletext receiving circuit comprising:
a frequency characteristic enhancement circuit for amplifying a frequency band of the teletext signal when the frequency band has an amplitude lower than a predetermined level; and
a slicing circuit for binarizing an output of the frequency characteristic enhancement circuit and outputting binarized data.

2. The teletext receiving circuit of claim 1, wherein the slicing circuit includes:
a first MIN/MAX circuit for detecting maximum and minimum values of the output of the frequency characteristic enhancement circuit during a period of the teletext reference signal,
a second MIN/MAX circuit for detecting maximum and minimum values of the output of the frequency characteristic enhancement circuit during a period of time between a current horizontal synchronization interval and a next horizontal synchronization interval,
a slicing level calculation circuit for calculating, in accordance with an output of the first MIN/MAX circuit, a slicing level for binarizing the output of the frequency characteristic enhancement circuit,
a teletext data extraction circuit for binarizing the output of the frequency characteristic enhancement circuit according to the slicing level, and
a determination circuit for determining a state of the composite signal by using the maximum and minimum values obtained by the first MIN/MAX circuit and the maximum and minimum values obtained by the second MIN/MAX circuit; the frequency characteristic enhancement circuit includes:
a band-pass filter for extracting a frequency component of the teletext reference signal,
a selection circuit for selecting and outputting one of input signals in accordance with a determination result obtained by the determination circuit,
a multiplier for multiplying an output of the selection circuit by a multiplier determined according to the amplitude of an output of the band-pass filter, and
an adder for adding an output of the multiplier and the digital input signal together; and
the output of the band-pass filter and the digital input signal are input to the selection circuit.

3. The teletext receiving circuit of claim 2, wherein when the four values, which are the maximum and minimum values detected by the first MIN/MAX circuit and the maximum and minimum values detected by the second MIN/MAX circuit, fall within a predetermined value range, the determination circuit determines that the composite signal is a minute signal, and when a difference between the maximum and minimum values obtained by the first MIN/MAX circuit is greater than a predetermined value, and a difference between the maximum and minimum values obtained by the second MIN/MAX circuit is smaller than a predetermined value, the determination circuit determines that the composite signal is in an abnormal condition; and
the selection circuit selects and outputs the digital input signal when the determination circuit makes the determinations of the minute signal and the abnormal condition, and the selection circuit selects and outputs the output of the band-pass filter in other cases.

4. The teletext receiving circuit of claim 2, further comprising:
a weak electric field detection circuit for detecting whether or not the digital input signal is a noise condition signal,
wherein the frequency characteristic enhancement circuit further includes a low-pass filter for removing a part whose frequency is higher than the band of the teletext signal;
the determination circuit also uses a detection result obtained by the weak electric field detection circuit to determine the state of the composite signal; and
the selection circuit also receives an output of the low-pass filter.

5. The teletext receiving circuit of claim 4, wherein when the weak electric field detection circuit detects that the digital input signal is a noise condition signal, a difference between the maximum and minimum values detected by the first MIN/MAX circuit is smaller than a predetermined value, and a difference between the maximum and minimum values detected by the second MIN/MAX circuit is smaller than a predetermined value, then the determination circuit determines that the digital input signal is a noise condition signal; and
when the determination circuit determines that the digital input signal is a noise condition signal, the selection circuit selects and outputs the output of the low-pass filter.

6. A teletext receiving method for receiving a teletext signal superimposed on a vertical blanking interval in an analog TV composite signal, the method comprising:
a frequency characteristic enhancement step for amplifying a frequency band of the teletext signal when the frequency band has an amplitude lower than a predetermined level; and
a slicing step for binarizing an output produced in the frequency characteristic enhancement step and outputting binarized data.
